(19) United States
(12) Patent Application Publication
(10) Pub. No.: US 2026/0036705 A1
(43) Pub. Date: Feb. 5, 2026

(54) DETECTORS FOR COMPUTED TOMOGRAPHY SCANNERS AND RELATED ASSEMBLIES AND SYSTEMS

(71) Applicant: Analogic Corporation, Peabody, MA (US)

(72) Inventors: Abdelaziz Ikhlef, Hudson, OH (US); Randy Luhta, Chardon, OH (US); Mark Magalotti, Broadview Heights, OH (US); Ron Sharpless, Aurora, OH (US); Douglas Abraham, Topsfield, MA (US)

(21) Appl. No.: 18/795,029

(22) Filed: Aug. 5, 2024

(51) Int. Cl. G01T 1/29; G01T 1/24

(52) U.S. Cl. CPC G01T 1/2971; G01T 1/241; G01T 1/243; G01T 1/244

(57) ABSTRACT

Detectors for computed tomography scanners may include a cathode, a cadmium telluride material, a cadmium zinc telluride material, or a silicon material adjacent to the cathode, and an array of anodes located on a side of the cadmium telluride material, the cadmium zinc telluride material, or the silicon material opposite the cathode, A substrate may be located proximate to the array of anodes, anodes of the array of anodes electrically connected to the substrate. A microelectronic device may be located on a side of the substrate opposite the cadmium telluride material, the cadmium zinc telluride material or the silicon material. The microelectronic device may be electrically connected to the substrate with the microelectronic device mounted to the substrate in a flip-chip orientation. Electrically conductive elements may be located adjacent to the microelectronic device and electrically connected to the substrate.

### FIELD

This application relates generally to detectors for computed tomography scanners and related assemblies and systems. More specifically, this application relates to detectors for computed tomography scanners that may produce higher quality signals representative of detected radiation, may increase signal generation and processing speed, and may enable pre-verification of operability before use when compared to other detectors known to the inventors.

### BACKGROUND

Radiation imaging modalities such as CT systems, single-photon emission computed tomography (SPECT) systems, digital projection systems, and/or line-scan systems, for example, are useful to provide information, or images, of interior aspects of an object under examination. Generally, the object is exposed to radiation including photons (e.g., such as x-rays, gamma rays, etc.), and one or more images are formed based upon the radiation absorbed and/or attenuated by the interior aspects of the object, or rather a number of radiation photons that are able to pass through the object. Generally, highly dense aspects of the object absorb and/or attenuate more radiation than less dense aspects, and thus an aspect having a higher density, such as a bone or metal, for example, will be apparent when surrounded by less dense aspects, such as muscle or clothing.

The detector array typically comprises a plurality of detector cells, respectively configured to convert detected radiation into electrical signals. Based upon the number of radiation photons detected by respective detector cells and/or the electrical charge generated by respective detector cells between samplings, images can be reconstructed that are indicative of the density, z-effective, shape, and/or other properties of the object and/or aspects thereof.

The number of detectors comprised within a detector array may be application specific. For example, in security applications where it is desirable to continuously translate an object (e.g., on a conveyor belt) while acquiring volumetric data about the object, the number of detector cells may exceed 100,000. In other applications, such as in mammography applications where the object is stationary and two-dimensional data is acquired, the number of detectors may exceed 10,000,000. In some examples, respective detectors may be capable of counting individual photons received at the detectors, which detectors may be referred to as “single-photon detectors” (SPDs).

To, among other things, facilitate a modular design of detector arrays, self-contained detector units (e.g., also referred to as tiles) may be used. Respective detector assemblies may include a plurality of detectors (e.g., 128 detectors, 256 detectors, etc.) and can be arranged with other detector assemblies to form a detector array having a desired number of detectors, a desired size, and/or a desired shape. For example, U.S. Pat. Nos. 7,582,879 and 10,488,532, assigned to Analogic Corporation, describe a scanning system including, among other things, a scintillator, a photodetector array, and an integrated circuit (e.g., including, among other things, an A/D converter).

### BRIEF SUMMARY

In some examples, detectors for computed tomography scanners may include a cathode, a cadmium telluride material, a cadmium zinc telluride material, or a silicon material adjacent to the cathode, and an array of anodes located on a side of the cadmium telluride material, the cadmium zinc telluride material, or the silicon material opposite the cathode, A substrate may be located proximate to the array of anodes, anodes of the array of anodes electrically connected to the substrate. A microelectronic device may be located on a side of the substrate opposite the cadmium telluride material, the cadmium zinc telluride material or the silicon material. The microelectronic device may be electrically connected to the substrate with the microelectronic device mounted to the substrate in a flip-chip orientation. Electrically conductive elements may be located adjacent to the microelectronic device and electrically connected to the substrate.

In other examples, assemblies of detectors for computed tomography scanners may include an array of detectors. Each detector of the array of detectors may include a cathode, a detector material capable of converting each photon received at the detector material into an electrical signal to perform photon counting computed tomography, the detector material in contact with the cathode, and an array of anodes located on a side of the detector material opposite the cathode. A first major surface of a first substrate may face the array of anodes, anodes of the array of anodes electrically connected to the substrate. A microelectronic device may be located on a side of the substrate opposite the detector material, the microelectronic device electrically connected to the substrate with the microelectronic device mounted to the substrate in a flip-chip orientation. A carrier may support the array of detectors. The carrier may include a second substrate electrically connected to each first substrate of the array of detectors by electrically conductive elements located laterally adjacent to the microelectronic device and in contact with respective first substrates and the second substrate. A connector may be located on a side of the second substrate opposite the array of detectors, the connector electrically connected to the electrically conductive elements.

In other examples, computed tomography scanners may include a radiation source and a detector positioned, oriented, and configured to receive at least a portion of radiation emitted by the radiation source. The detector may include an array of detection assemblies. At least one of the detection assemblies may include an array of detectors. Each detector of the array of detectors may include a cathode, a detector material capable of converting each photon received at the detector material into an electrical signal to perform photon counting computed tomography, the detector material adjacent to the cathode, and an array of anodes located on a side of the detector material opposite the cathode. A first major surface of a first substrate may face the array of anodes, anodes of the array of anodes electrically connected to the substrate. A microelectronic device may be located on a side of the substrate opposite the detector material, the microelectronic device electrically connected to the substrate with the microelectronic device mounted to the substrate in a flip-chip orientation. A carrier may support the array of detectors. The carrier may include a second substrate electrically connected to each first substrate of the array of detectors by electrically conductive elements located laterally adjacent to the microelectronic device and in contact with respective first substrates and the second substrate. A connector may be located on a side of the second substrate opposite the array of detectors, the connector electrically connected to the electrically conductive elements.

### BRIEF DESCRIPTION OF THE SEVERAL VIEWS OF THE DRAWINGS

While this disclosure concludes with claims particularly pointing out and distinctly claiming specific examples, various features and advantages of subject matter within the scope of this disclosure may be more readily ascertained from the following description when read in conjunction with the accompanying drawings, in which:

FIG. 1 is a schematic of a scanning system configured to perform radiation-based scanning;

FIG. 2 is a cross-sectional side view of a detector for a computed tomography scanner, such as, for example, the scanning system of FIG. 1;

FIG. 3 is a bottom surface view of the detector of FIG. 2;

FIG. 4 is a cross-sectional side view of an assembly of detectors, which may include multiple detectors as depicted in FIGS. 2 and 3;

FIG. 5 is a bottom surface view of the assembly of FIG. 4;

FIG. 6 is a cross-sectional side view of another example of a detector for a computed tomography scanner, such as, for example, the scanning system of FIG. 1;

FIG. 7 is a cross-sectional side view of another example of an assembly of detectors, which may include multiple detectors as depicted in FIG. 6; and

FIG. 8 is a top surface view of an array of detection assemblies for a computed tomography scanner, such as, for example, the scanning system of FIG. 1.

### DETAILED DESCRIPTION

The illustrations presented in this disclosure are not meant to be actual views of any particular scanning system for performing radiation-based (e.g., computed tomography (CT)) scanning or component thereof or component thereof, but are merely idealized representations employed to describe illustrative embodiments. Thus, the drawings are not necessarily to scale.

Disclosed embodiments relate generally to detectors for computed tomography scanners that may produce higher quality signals representative of detected radiation, may increase signal generation and processing speed, and may enable pre-verification of operability before use when compared to other detectors known to the inventors. More specifically, disclosed are embodiments of scanning systems configured to perform radiation-based scanning that may include detectors having three-dimensionally stacked and packaged components, which may reduce the capacitance of electrical circuitry in the detectors, may result in less noise being introduced into electrical signals carried by the circuitry, and may be less susceptible to external interference. In some examples, the detectors disclosed herein may further include mechanical attachment structures and electrical connectors, which may enable more precise alignment of the detectors, resulting in higher quality and fidelity imaging, and may enable individual detectors to be more easily installed and removed for repair and replacement when compared to detector designs known to the inventors.

As used herein, the terms “substantially” and “about” in reference to a given parameter, property, or condition means and includes to a degree that one of ordinary skill in the art would understand that the given parameter, property, or condition is met with a degree of variance, such as within acceptable manufacturing tolerances. For example, a parameter that is substantially or about a specified value may be at least about 90% the specified value, at least about 95% the specified value, at least about 99% the specified value, or even at least about 99.9% the specified value.

As used herein, spatially relative terms, such as “upper,” “lower,” “above,” “below,” “bottom,” and “top,” are for ease of description in identifying one element's relationship to another element, as illustrated in the figures. Unless otherwise specified, the spatially relative terms are intended to encompass different orientations of the materials in addition to the orientation depicted in the figures. Thus, the term “upper” can encompass elements above, below, to the left of, or to the right of other elements, depending on the orientation of a device. The materials may be otherwise oriented (rotated ninety degrees, inverted, etc.) and the spatially relative descriptors used herein interpreted accordingly.

As used herein, the terms “memory” and “memory device” shall be construed to exclude transitory signals.

As used herein in connection with electrical connections, the terms “connect,” “connected,” and “connection” mean and include direct contact and electrical transmissibility between adjacent, named elements as well as indirect contact via intervening elements and electrical transmissibility from one named element to another through such intervening elements. For example, a microelectronic device is electrically connected to a substrate when the two are adjacent to one another with only solder balls therebetween and also when the two are separated from one another by an interposer and solder balls between each element.

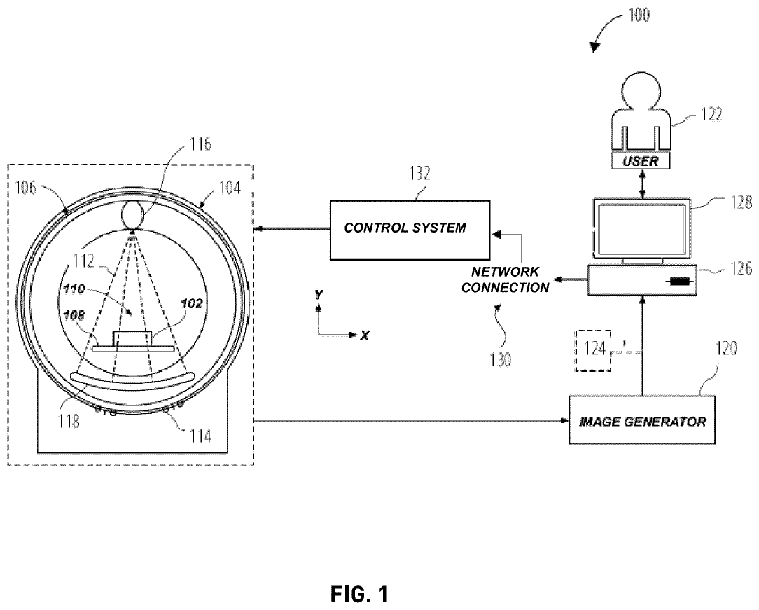

FIG. 1 is a schematic of a scanning system 100 configured to perform radiation-based (e.g., CT) scanning. Devices, structures, and techniques in accordance with this disclosure may find applicability with, for example, CT scanner systems, line-scan systems, digital projection systems, diffraction systems, and/or other systems including a radiation detector system. The scanning system 100 may be configured to examine one or more subjects 102 (e.g., a human at a medical facility, a series of suitcases at an airport, freight, parcels, etc.). The scanning system 100 may include, for example, a stator 104 and a rotor 106 rotatable relative to the stator 104. During examination, the subject(s) 102 may be located on a support 108, such as, for example, a bed, roller conveyor, or conveyor belt, that is selectively positioned in an examination region 110 (e.g., a hollow bore in the rotor 106 in which the subject 102 is exposed to radiation 112), and the rotor 106 may be rotated about the subject 102 by a motivator 114 (e.g., motor, drive shaft, chain, etc.).

The rotor 106 may surround a portion of the examination region 110 and may be configured as, for example, a gantry supporting at least one radiation source 116 (e.g., an ionizing x-ray source, gamma-ray source, etc.) oriented to emit radiation toward the examination region 110 and an array of detectors 118 supported on a substantially diametrically opposite side of the rotor 106 relative to the radiation source(s) 116. The array of detectors 118 may include a plurality of individual detectors positioned, oriented, and configured to receive at least a portion of radiation 112 emitted by the radiation source 116. During an examination of the subject 102, the radiation source 116 may emit fan and/or cone shaped radiation 112 configurations into the examination region 110. The radiation 112 can be emitted, for example at least substantially continuously or intermittently (e.g., a pulse of radiation 112 followed by a resting period during which the radiation source 116 is not activated).

As the emitted radiation 112 traverses the subject 102, the radiation 112 may be attenuated differently by different aspects of the subject 102. Because different aspects attenuate different percentages of the radiation 112, an image or images can be generated based upon the attenuation, or variations in the number of radiation photons that are detected by detectors of the array of detectors 118. For example, more dense aspects of the subject 102, such as an inorganic material, may attenuate more of the radiation 112 (e.g., causing fewer photons to be detected by the array of detectors 118) than less dense aspects, such as organic materials.

The array of detectors 118 may include, for example, many individual detection assemblies (also referred to as detection modules, detector modules, and/or the like) arranged in a pattern (e.g., a row or a grid) on one or more supports, which may be operatively connected to one another to form the array of detectors 118. In some embodiments, the detection assemblies may be configured to indirectly convert (e.g., using a scintillator array and photodetectors) detected radiation into analog signals. Further, as will be described in more detail below, the array of detectors 118, or detection assemblies thereof, may include electronic circuitry, such as, for example, an analog-to-digital (A/D) converter, configured to filter the analog signals, digitize the analog signals, and/or otherwise process the analog signals and/or digital signals generated thereby. Digital signals output from the electronic circuitry may be conveyed from the array of detectors 118 to digital processing components configured to store data associated with the digital signals and/or further process the digital signals.

In some examples, the digital signals may be transmitted to an image generator 120 configured to generate image space data, also referred to as images, from the digital signals using a suitable analytical, iterative, and/or other reconstruction technique (e.g., backprojection reconstruction, tomosynthesis reconstruction, iterative reconstruction, etc.). In this way, the data may be converted from projection space to image space, a domain that may be more understandable by a user 122 viewing the image(s), for example. Such image space data may depict a two dimensional representation of the subject 102 and/or a three dimensional representation of the subject 102. In other embodiments, the digital signals may be transmitted to other digital processing components, such as a threat analysis component 124, for processing.

The illustrated scanning system 100 may also include a terminal 126 (e.g., a workstation or other computing device), configured to receive the image(s), which can be displayed on a monitor 128 to the user 122 (e.g., security personnel, medical personnel, etc.). In this way, a user 122 can inspect the image(s) to identify areas of interest within the subject 102. The terminal 126 may also be configured to receive user input which may direct operations of the scanning system 100 (e.g., a rate at which the support 108 moves, activation of the radiation source 116, etc.) and connected to additional terminals 126 through a network 130 (e.g., a local area network or the Internet).

A control system 132 may be operably coupled to the terminal 126. The control system 132 may be configured to automatically control at least some operations of the scanning system 100. For example, the control system 132 may be configured to directly and/or indirectly, automatically, and dynamically control the rate at which the support 108 moves through the examination region 110, the rate at which the rotor 106 rotates relative to the stator 104, activation, deactivation, and output level of (e.g., intensity of radiation emitted by) the radiation source 116, or any combination or subcombination of these and/or other operating parameters. In some embodiments, the control system 132 may also accept manual override instructions from the terminal 126 and issue instructions to the scanning system 100 to alter the operating parameters of the scanning system 100 based on the manual override instructions. The control system 132 may be located proximate to a remainder of the scanning system 100 (e.g., integrated into the same housing or within the same room as the remaining components) or may be remote from the scanning system 100 (e.g., located in another room, such as, for example, an on-site control room, an off-site server location, a cloud storage system). The control system 132 may be dedicated to control a single scanning system 100, or may control multiple scanning systems 100 in an operative grouping or subgrouping.

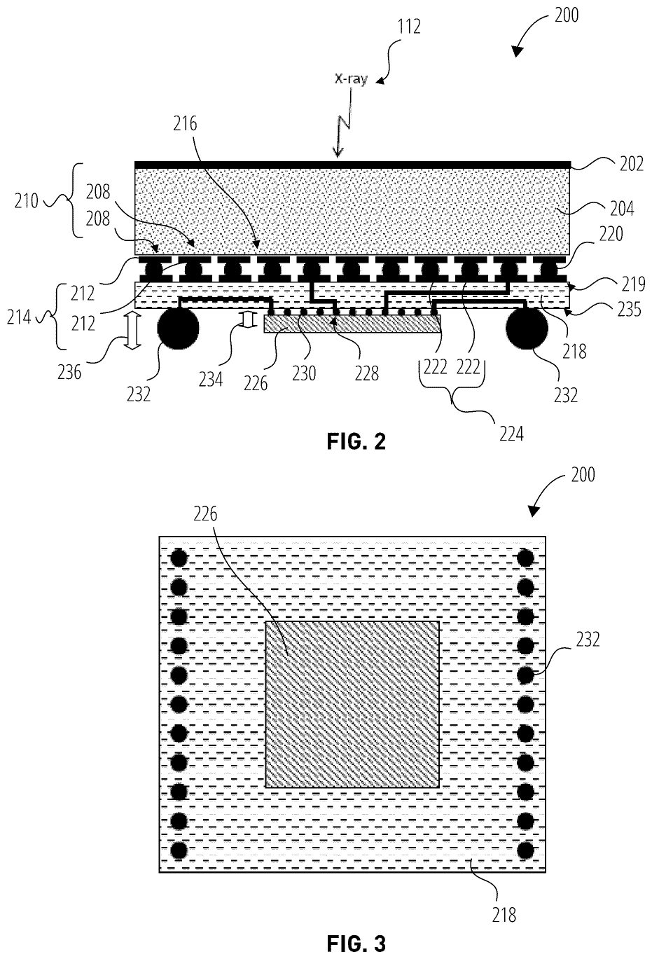

FIG. 2 is a cross-sectional side view of a detector 200 for a computed tomography scanner, such as, for example, the scanning system 100 of FIG. 1. The detector 200 may include, for example, a cathode 202 which may be positioned for orientation toward a radiation source, such that radiation 112 emitted by the radiation source may first encounter the cathode 202. The cathode 202 may be configured as, for example, an electrode from which current may flow responsive to incident radiation.

The detector 200 may include a detector material 204 capable of converting each photon received at the detector material 204 into an electrical signal. For example, the detector material 204 of the detector 200 may enable the detector 200 to perform photon counting computed tomography. More specifically, the detector material 204 may include, for example, a cadmium telluride material, a cadmium zinc telluride material, or a silicon material. The detector material 204 may be in contact with the cathode 202. In some examples, the cathode 202 may include the an electrically conductive material distinct from the detector material 204. For example, the cathode 202 may include a metal or metal alloy material. More specifically, the cathode 202 may include a gold, silver, copper, aluminum, or alloys including one or more of the foregoing. In some examples, the detector 200 may include an intermediate material between the cathode 202 and the detector material 204. For example, the detector 200 may include an intermediate semiconductor material distinct from both the cathode 202 and the detector material 204 or may include a doped region of the detector material 204 located adjacent to the cathode 202.

An array of anodes 210 located on a side of the detector material 204 opposite the cathode 202. For example, the array of anodes 210 may be positioned for orientation away from the radiation source, such that radiation 112 emitted by the radiation source must first encounter the cathode 202 and the detector material 204 before reaching anodes 208 of the array of anodes 210. Each anode 208 of the array of anodes 210 may be configured as, for example, electrodes to which current may flow, and from which signals representative of radiation 112 received at the detector 200 may be generated for receipt and processing by downstream microelectronic devices. In some examples, the anodes 208 of the array of anodes 210 may include an electrically conductive material distinct from the detector material 204. For example, the anodes 208 may include a metal or metal alloy material. More specifically, the anodes 208 may include a gold, silver, copper, aluminum, or alloys including one or more of the foregoing. In some examples, the detector 200 may include an intermediate material between the detector material 204 and the anodes 208. For example, the detector 200 may include an intermediate semiconductor material distinct from both the anodes 208 and the detector material 204 or may include a doped region of the detector material 204 located adjacent to the anodes 208.

A corresponding array of output pads 214 may be located proximate to the array of anodes 210. For example, output pads 212 of the array of output pads 214 may include discrete quantities of an electrically conductive material and may cover respective anodes 208 of the array of anodes 210. More specifically, the output pads 212 of the array of output pads 214 may be located on a major surface 216 of the detector material 204, and each region of the detector material 204 covered by a respective output pad 212 may form an anode 208. Depending on where a given photon of the radiation 112 is received by the detector material 204, the resultant increase in electron current within the detector material 204 may be concentrated in those regions closest to the position and path of the photon, which may cause the intensity of a signal generated by one anode 208, or a small grouping of anodes 208, to exceed a minimum threshold (e.g., greater than an amount caused by ambient radiation) and the signal to be receivable from the corresponding output pad 212 of the array of output pads 214.

A first major surface 219 of the first substrate 218 may be located proximate to, and may face, the array of anodes 210, and anodes 208 of the array of anodes 210 may be electrically connected to the first substrate 218. For example, the first substrate 218 may be configured to receive signals representative of radiation 112 received at the detector material 204 and route them to downstream components. More specifically, the first substrate 218 may include a dielectric material (e.g., an organic material, a ceramic material, a composite material) and embedded, selectively connected quantities of electrically conductive material (e.g., traces, vias) to route and redistribute signals received at the first substrate 218 and carried by the respective quantities of electrically conductive material. As a specific, nonlimiting example, the first substrate 218 may include a printed circuit board, or a portion thereof. The traces and vias depicted in FIG. 2 are for illustrative purposes only and should in no way be considered limiting. Any interconnections may be formed within the first substrate 218, as a particular application or implementation of connected components may require or benefit from.

First electrically conductive elements 220 may be located between, and may electrically connect, the array of anodes 210 to the first substrate 218. For example, a respective one of the first electrically conductive elements 220 may be located between, and in contact with, each output pad 212 of the array of output pads 214 and a corresponding bond pad 222 of an array of bond pads 224 of the first substrate 218. The first electrically conductive elements 220 may include an electrically conductive material (e.g., aluminum, tin, gold, silver, copper, solder, electrically conductive epoxy). More specifically, the first electrically conductive elements 220 may include a reflowable, electrically conductive material, which may mechanically secure and electrically connect the output pad 212 of the array of output pads 214 to the bond pads 222 of the array of bond pads 224. As a specific, nonlimiting example, the first electrically conductive elements 220 may include a tin-bismuth solder material. The first electrically conductive elements 220 may be configured as, for example, balls, bumps, domes, columns, pillars, etc.

A microelectronic device 226 may be located on a side of the first substrate 218 opposite the detector material 204. The microelectronic device 226 may be electrically connected to the first substrate 218 with the microelectronic device 226 mounted to the first substrate 218 in a flip-chip orientation. For example, the microelectronic device 226 may have a major surface 228 bearing electrical connections for input to and output from the microelectronic device 226, which major surface 228 may face toward and be located proximate to the first substrate 218, with second electrically conductive elements 230 interposed between, electrically connecting, and mechanically securing the microelectronic device 226 and the first substrate 218. As a specific, nonlimiting example, the major surface 228 of the microelectronic device 226 may be an active surface having integrated circuitry embedded therein and/or supported thereon, and the active surface may face toward and be located proximate to the first substrate 218. The second electrically conductive elements 230 may be at least substantially similar to the first electrically conductive elements 220 described previously, though different materials, sizes, and other characteristics may be selected for the second electrically conductive elements 230 when compared to the first electrically conductive elements 220. In other examples, the microelectronic device 226 may be oriented with the major surface 228 facing away from the first substrate 218, and the microelectronic device 226 and the first substrate 218 may be electrically connected and mechanically secured to one another in other ways (e.g., utilizing an adhesive material and wire bonds).

The microelectronic device 226 may be configured to receive electrical signals from the detector material 204 and to prepare those electrical signals for output from the detector 200. In some examples, the microelectronic device 226 may process the electrical signals from the detector material 204 to provide outputs more easily receivable and further processable by downstream components. For example, the microelectronic device 226 may include a filter, such as, for example, a low-pass filter, a high-pass filter, and/or a band pass filter, which may be configured to filter out noise and ensure signals representative of incident radiation (e.g., individual photons for counting) are captured. As another example, the microelectronic device 226 may include one or more analog-to-digital converters, digital-to-analog converters (DACs), logic gates, multiplexers, microprocessors, digital signal processors (DSPs), memory, power management circuits, operational amplifiers, charge sensitive amplifiers (CSAs), shaper amplifiers, comparators, threshold DACs, counters, or any combination or sub-combination of these. As specific, nonlimiting examples, the microelectronic device 226 may include an application-specific integrated circuit (ASIC), field-programmable gate array (FPGA), system-on-chip (SoC), application-specific standard product (ASSP), or any combination or sub-combination of these.

The detector 200 may include third electrically conductive elements 232 located adjacent to the microelectronic device 226 and electrically connected to the first substrate 218. For example, the third electrically conductive elements 232 may be electrically connected through the first substrate 218 to the microelectronic device 226, may be positioned and configured for outputting electrical signals from the detector 200 to downstream components, and may mechanically secure, or at least assist in mechanically securing, the detector 200 to a receiving component. The third electrically conductive elements 232 may be at least substantially similar to the first electrically conductive elements 220 described previously, though different materials, sizes, and other characteristics may be selected for the third electrically conductive elements 232 when compared to the first electrically conductive elements 220.

A first, greatest height 234 of the microelectronic device 226 as measured from the first substrate 218 in a direction perpendicular to a second, closest major surface 235 of the first substrate 218 may be less than or equal to a second, smallest height 236 of the third electrically conductive elements 232 as measured from the first substrate 218 in the same direction. For example, the first, greatest height 234 may be between about 10% and about 99% of the second, smallest height 236. More specifically, the first, greatest height 234 may be, for example, between about 25% and about 95% of the second, smallest height 236. As a specific, nonlimiting example, the first, greatest height 234 may be between about 50% and about 90% (e.g., about 75%, about 85%) of the second, smallest height 236. With such a configuration, the third electrically conductive elements 232 may have sufficient clearance to make connection to a receiving component while enabling the microelectronic device 226 to be located on the same side of the first substrate 218 as the third electrically conductive elements 232.

By vertically stacking components of the detector 200 (when viewed in the orientation of FIG. 2), a technique that may be referred to in the art as “3D packaging,” the lateral footprints of the detectors 200 may be reduced when compared to detector designs that may not employ vertical stacking techniques. As a result, detectors 200 may be deployed at higher packing density, which may facilitate the capture of higher quality, higher fidelity, and higher resolution imaging. In addition, connections between the detector material 204, the microelectronic device 226, and other downstream components may be shorter, reducing noise and interference, improving signal quality, and increasing signal transfer speed and overall operation of the detector 200.

In addition, each component of the detector 200, such as, for example, the detector material 204, the first substrate 218, and the microelectronic device 226 may be separately manufacturable. In examples where such components are made separately, each component may be tested and confirmed operational before assembly into the detector 200. When compared to manufacturing techniques requiring that such components be formed as part of the same process, separate manufacturing and testing may increase yield of operational detectors 200 and reduce the need to replace defective detectors 200.

FIG. 3 is a bottom surface view of the detector 200 of FIG. 2. In some examples, such as that shown in FIG. 3, the third electrically conductive elements 232 of the detector 200 may be located in rows flanking the microelectronic device 226 and extending along lateral peripheries of the first substrate 218. For example, the third electrically conductive elements 232 may form two rows located proximate to two, opposite sides of the microelectronic device 226 (left and right sides when viewed in the orientation and surface view of FIG. 3) and extend along corresponding lateral peripheries of the first substrate 218. In some other examples where the microelectronic device 226 is rectangular in shape when viewed in the surface view of FIG. 3, the third electrically conductive elements 232 of the detector 200 may be located in a single row proximate to one of the sides of the microelectronic device 226, may partially surround, and be located proximate to three sides of, the microelectronic device 226, or may completely surround, and be located proximate to four sides of, the microelectronic device 226.

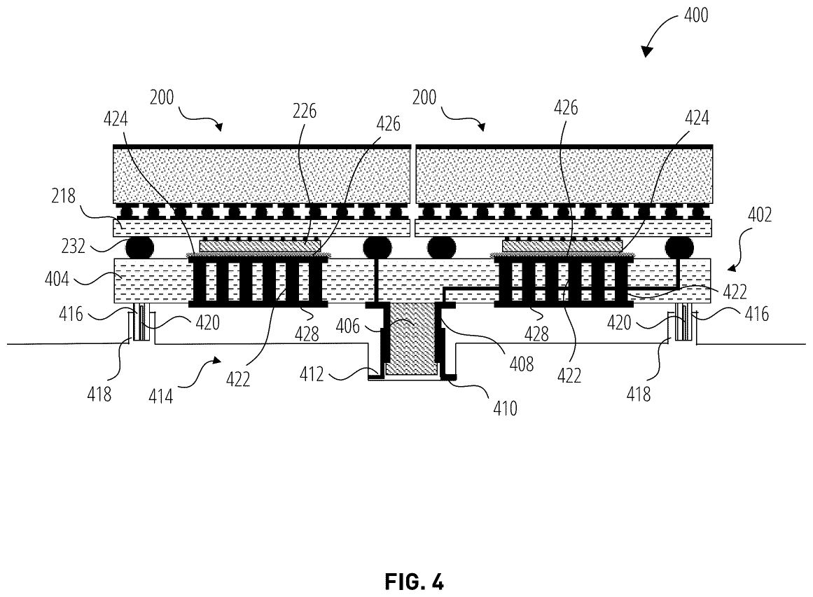

FIG. 4 is a cross-sectional side view of a detection assembly 400, which may include multiple detectors 200 as depicted in FIGS. 2 and 3. Though the detectors 200 shown and described in connection with FIGS. 2 and 3 are referenced and depicted again in connection with this FIG. 4, detection assemblies 400 in accordance with this disclosure may utilize detectors having configurations other than those specifically depicted and described herein. The detectors 200 of the detection assembly 400 may be arranged, such as, for example, in an array and/or grid. The detection assembly 400 may facilitate deployment in a scanning system 100, such as that depicted and described in connection with FIG. 1, enable more precise positioning and orientation of the detectors 200 with respect to an examination region 110 (see FIG. 1), and enable removal, replacement, and repair of a given detection assembly 400.

The detection assembly 400 may include a carrier 402 supporting the array of detectors 200. The carrier 402 may include a second substrate 404 electrically connected to each first substrate 218 of the array of detectors 200. For example, the third electrically conductive elements 232 located laterally adjacent to the microelectronic device 226 of each respective detector 200 may be in contact with both the respective first substrates 218 and the second substrate 404. More specifically, the third electrically conductive elements 232 may be electrically connected and mechanically secured to output pads of the first substrate 218 and to lands of the second substrate 404.

The second substrate 404 may include, for example, a dielectric material (e.g., an organic material, a ceramic material, a composite material) and embedded, selectively connected quantities of electrically conductive material (e.g., traces, vias) to route and redistribute signals received at the second substrate 404 from the first substrate 218 and carried by the respective quantities of electrically conductive material. As a specific, nonlimiting example, the second substrate 404 may include a printed circuit board, or a portion thereof. The traces and vias depicted in FIG. 4 are for illustrative purposes only and should in no way be considered limiting. Any interconnections may be formed within the second substrate 404, as a particular application or implementation of connected components may require or benefit from.

The carrier 402 may further include a connector 406 located on a side of the second substrate 404 opposite the array of detectors 200. The connector 406 may be electrically connected to the third electrically conductive elements 232, such as, for example, utilizing traces and vias of the second substrate 404. The connector 406 may be positioned and configured to electrically connect each of the detectors 200 supported by the carrier 402 to downstream components. The connector 406 may include, for example, electrical contacts 408 positioned and oriented to make physical contact, and electrically connect, with corresponding contacts 410 of a mating connector 412. More specifically, the connector 406 may be configured as, for example, a pin connector (e.g., a 30-pin connector, a 60-pin connector) or an edge connector (e.g., a Peripheral Component Interconnect Express (PCIe) connector), and may embody the component for insertion or the socket for receipt. The mating connector 412 may be supported on, for example, a frame 414 of or supported by a stator 104 (see FIG. 1) of a scanning system 100. In some examples, the connector 406, the mating connector 412, or both may be movable with respect to the carrier 402 and/or the frame 414, which may reduce mechanical strain on the connector 406 and the mating connector 412. For example, one or more of the connector 406 and the mating connector 412 may be located on a ribbon cable. In other examples, the design of the connector 406 and/or the mating connector 412 itself may accommodate flexibility in alignment to facilitate connection and alleviate stress that may otherwise be induced by a misaligned connection. For example, the connector 406 and/or the mating connector 412 may include flexible and/or movable contacts within the connector 406 and/or the mating connector 412, which may displace to reorient responsive to receipt of the corresponding counterpart.

In some examples, the carrier 402 may include one or more mechanical attachment structures 416 located on a side of the carrier 402 opposite the array of detectors 200. The mechanical attachment structures 416 may be, for example, positioned and configured to mechanically secure the carrier 402 to, and align the carrier 402 with respect to, a support. More specifically, the mechanical attachment structures 416 may include, for example, protrusions (e.g., pins, threaded shafts) or recesses (e.g., holes in the carrier 402, blind holes in the carrier 402, threaded recesses in the carrier) for insertion into, or receipt by, mating mechanical attachment structures 418 of a frame 414 of or supported by the stator 104 (see FIG. 1). As a specific, nonlimiting example, the mechanical attachment structures 416 may include posts extending from, and secured to, the carrier 402, which may have threaded bores extending at least partially through, and at least substantially axially aligned with, the posts for receiving bolts 420 therein. The mechanical attachment structures 416 may be positioned and configured to align the carrier 402 with respect to, and secure the carrier 402 to, the frame 414. Having such mechanical attachment structures 416 may enable more reliable and consistent positioning and orientation of the detectors 200, which may in turn enable more accurate and consistent imaging.

In some examples, the carrier 402 may include thermally conductive vias 422 extending at least partially through the second substrate 404 and located proximate to respective microelectronic devices 226 of the array of detectors 200. The thermally conductive vias 422 may be positioned and configured to facilitate transfer of heat away from the microelectronic device 226. For example, a thermal interface material 424 may be located between each microelectronic device and a closest thermally conductive via 422 of the thermally conductive vias 422. More specifically, the carrier 402 may include, for example, an array of first thermal spreaders 426 located on a side of the second substrate 404 facing the array of detectors 200 and for positioning proximate to respective microelectronic devices 226, with the thermal interface material 424 interposed between the microelectronic devices 226 and the first thermal spreaders 426. The first thermal spreaders 426 may be in thermal communication with the thermally conductive vias 422. For example, the first thermal spreaders 426 may be in contact with the thermally conductive vias 422, optionally with another mass of thermal interface material therebetween, or the material of the first thermal spreaders 426 may be contiguous with the material of the thermally conductive vias 422. The carrier 402 may further include, for example, an array of second thermal spreaders 428 located on a side of the second substrate 404 opposite the array of detectors 200 and for positioning distal from the microelectronic devices 226. The second thermal spreaders 428 may be in thermal communication with the thermally conductive vias 422. For example, the second thermal spreaders 428 may be in contact with the thermally conductive vias 422, optionally with another mass of the thermal interface material therebetween, or the material of the second thermal spreaders 428 may be contiguous with the material of the thermally conductive vias 422. The thermally conductive vias 422, thermal interface material 424, first thermal spreaders 426, and second thermal spreaders 428 may collectively provide a path of least thermal resistance for heat generated by operation of the microelectronic devices 226 to escape the detection assembly 400. Having such thermal management may enable more consistent operation within target operating temperatures utilizing microelectronic devices 226 having higher average power ratings, across a wider variety of ambient temperatures, and under a wider variety of operational conditions.

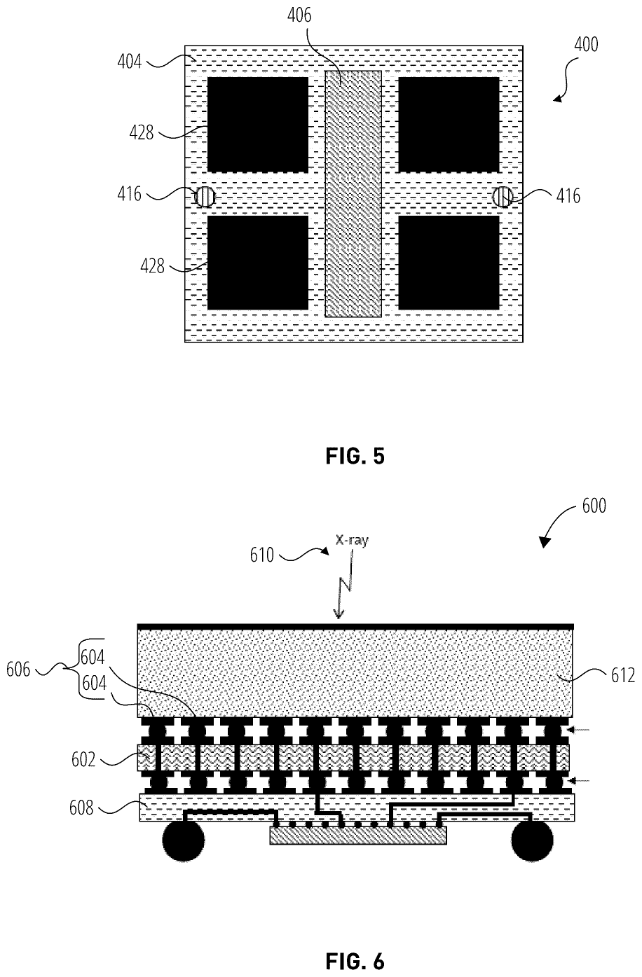

FIG. 5 is a bottom surface view of the detection assembly 400 of FIG. 4. In some examples, the detection assembly 400 may have a rectangular peripheral shape when viewed in the bottom surface view of FIG. 5. The array of detectors 200 (see FIG. 4) may generally be arranged in a grid, with four detectors 200, each detector 200 (see FIG. 4) located proximate to a respective corner and within a respective quadrant of the detection assembly 400. As reflected in FIG. 5, the second thermal spreaders 428 corresponding to each detector 200 (see FIG. 4) may likewise be arranged in a grid, with four second thermal spreaders 428, each second thermal spreader 428 located proximate to a corresponding corner and within a corresponding quadrant of the detection assembly 400. In other examples, the detection assembly 400 may include different quantities of detection assemblies 400, such as, for example, two, eight, sixteen, etc.

Like the individual detectors 200 (see FIG. 4), the detection assemblies 400 may be testable for operation before deployment. Keeping the number of detectors 200 (see FIG. 4) per detection assembly 400 reasonable (e.g., two, four, eight) may make troubleshooting and replacing defective detectors 200 easier. Increasing the number of detectors 200 may make deployment easier, as fewer detection assemblies 400 may be required to form a complete array of detectors 118 (see FIG. 1). Specific numbers of detectors may depend, as a non-limiting example, on specific operating conditions.

FIG. 6 is a cross-sectional side view of another example of a detector 600 for a computed tomography scanner, such as, for example, the scanning system 100 of FIG. 1. The detector 600 may be at least substantially similar to the detector 200 shown and described in connection with FIG. 2, with certain differences shown in FIG. 6 and described below. For example, the detector 600 may include an interposer 602 located between and electrically connected to anodes 604 of the array of anodes 606 and the first substrate 608. More specifically, the interposer 602 may be configured to receive signals representative of radiation 610 received at the detector material 612 and route them to downstream components, including the first substrate 608. The interposer 602 may include a dielectric material (e.g., an organic material, a ceramic material, a composite material) and embedded, selectively connected quantities of electrically conductive material (e.g., traces, vias) to route and optionally redistribute signals received at the interposer 602 and carried by the respective quantities of electrically conductive material. As a specific, nonlimiting example, the interposer 602 may include a printed circuit board, a die of semiconducting material, a ceramic interposer substrate, or a portion of either of these. The vias depicted in FIG. 6 are for illustrative purposes only and should in no way be considered limiting. Any interconnections may be formed within the interposer 602, as a particular application or implementation of connected components may require or benefit from.

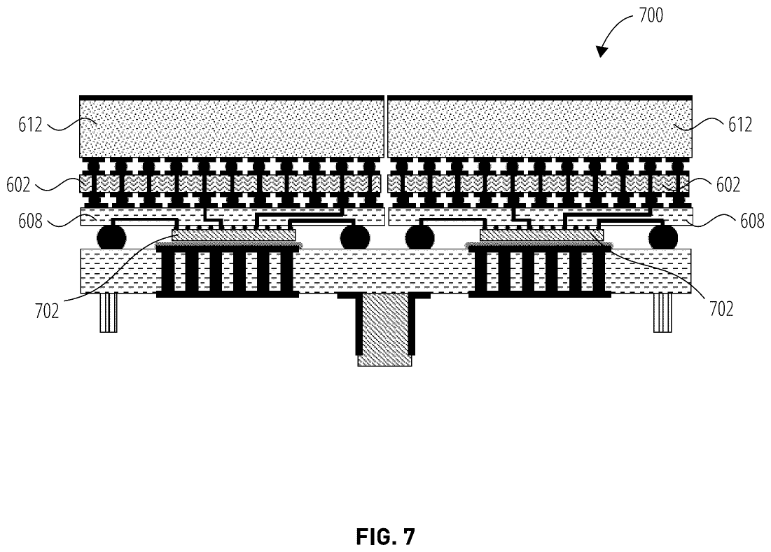

FIG. 7 is a cross-sectional side view of another example of an assembly 700 of detectors 600, which may include multiple detectors 600 as depicted in FIG. 6. One or more of the detectors 600 in the assembly 700 may include an interposer 602 located between the detector material 612 and the first substrate 608. Inclusion of the interposer 602 may facilitate easier removal, replacement, and repair of components of the assembly 700 and detectors 600, may further space heat-generating components (e.g., the microelectronic devices 702) from sensing components (e.g., the detector material 612), and may provide greater flexibility in routing signals between the respective components of the assembly 700. In some examples, a material of the interposer 602 may be selected for its ability to present a flat level surface and to provide rigidity to the detector 600, which may assist in making and maintaining electrical connections and may resist mechanical stresses and temperature-induced stresses. In some examples, a material of the interposer 602 may be selected to mitigate mismatches in coefficient of thermal expansion between the interposer 602 and the other components of the detector 600 and/or to be intermediate the coefficients of thermal expansion of the components of the detector 600 located proximate to the interposer 602. By so doing, the interposer 602 may reduce thermal and mechanical stresses on the detector 600, such as when experiencing thermal cycling.

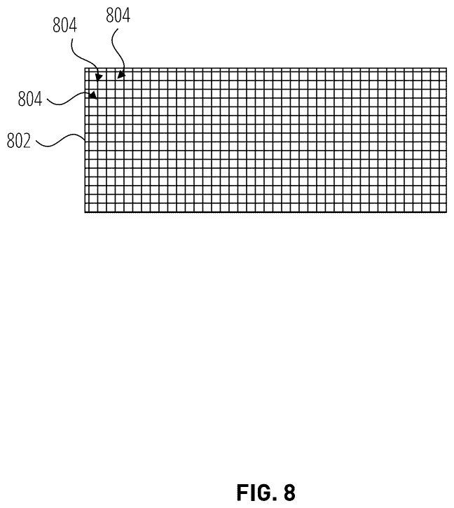

FIG. 8 is a top surface view of an array of detection assemblies 802 for a computed tomography scanner, such as, for example, the scanning system 100 of FIG. 1. In some examples, at least some detection assemblies 804 of the array of detection assemblies 802 may be located laterally and longitudinally adjacent to other detection assemblies 804 of the array of detection assemblies 802. For example, at least one of the detection assemblies 804 may have directly adjacent detection assemblies 804 located at least above or below and to the right or to the left of the respective detection assembly 804. More specifically, at least some of the detection assemblies 804 may have directly adjacent detection assemblies 804 in all locations laterally and longitudinally adjacent to the respective detection assemblies 804, above, below, to the left and to the right. In some examples, the array of detection assemblies 802 may form a rectangular grid. By tiling detection assemblies 804 in multiple directions, the detection assemblies 804 may facilitate.

Detectors, detection assemblies, and scanning systems in accordance with this disclosure may provide more accurate, higher quality, higher fidelity, and more reliable imaging, including by facilitating denser deployment of sensors and optionally employing photon counting scanning techniques. Such structures may also provide increased signal quality and speed of operation, and less signal noise and sensitivity to external interference, including by shortening electrical connections having lower capacitance for carrying signals generated during a scan. The structures disclosed herein may also facilitate easier deployment, removal, replacement, and repair of components, including by providing assemblies deployable to form arrays with capability for plug-and-play interconnection and easy, selective securing and alignment. Such structures may further lower cost and increase reliability by facilitating the testing and selection of components before assembly and deployment, which may increase yield and enable selection of known-operable components for further use.

Additional, nonlimiting examples within the scope of this disclosure include:
Example 1: A detector for a computed tomography scanner, comprising: a cathode; a cadmium telluride material, a cadmium zinc telluride material, or a silicon material adjacent to the cathode, an array of anodes located on a side of the cadmium telluride material, the cadmium zinc telluride material, or the silicon material opposite the cathode; a substrate located proximate to the array of anodes, anodes of the array of anodes electrically connected to the substrate; a microelectronic device located on a side of the substrate opposite the cadmium telluride material, the cadmium zinc telluride material or the silicon material, the microelectronic device electrically connected to the substrate with the microelectronic device mounted to the substrate in a flip-chip orientation; and electrically conductive elements located adjacent to the microelectronic device and electrically connected to the substrate.
Example 2: The detector of Example 1, wherein the microelectronic device comprises an application-specific integrated circuit (ASIC).
Example 3: The detector of Example 1 or Example 2, wherein a first, greatest height of the microelectronic device as measured from the substrate in a direction perpendicular to a closest major surface of the substrate is less than or equal to a second, smallest height of the electrically conductive elements as measured from the substrate in the direction.
Example 4: The detector of any one of Examples 1 through 3, wherein the electrically conductive elements are located in rows flanking the microelectronic device and extending along lateral peripheries of the substrate.
Example 5: The detector of any one of Examples 1 through 4, further comprising an interposer located between and electrically connected to the array of anodes and the substrate.
Example 6: An assembly of detectors for a computed tomography scanner, comprising: an array of detectors, each detector of the array of detectors comprising: a cathode; a detector material capable of converting each photon received at the detector material into an electrical signal to perform photon counting computed tomography, the detector material in contact with the cathode; and an array of anodes located on a side of the detector material opposite the cathode; a first substrate facing the array of anodes, anodes of the array of anodes electrically connected to the substrate; and a microelectronic device located on a side of the substrate opposite the detector material, the microelectronic device electrically connected to the substrate with the microelectronic device mounted to the substrate in a flip-chip orientation; and a carrier supporting the array of detectors, the carrier comprising: a second substrate electrically connected to each first substrate of the array of detectors by electrically conductive elements located laterally adjacent to the microelectronic device and in contact with respective first substrates and the second substrate; and a connector located on a side of the second substrate opposite the array of detectors, the connector electrically connected to the electrically conductive elements.
Example 7: The assembly of Example 6, wherein the detector material comprises a cadmium telluride material, a cadmium zinc telluride material, or a silicon material.
Example 8: The assembly of Example 6 or Example 7, wherein the carrier comprises thermally conductive vias extending at least partially through the second substrate and located proximate to respective microelectronic devices of the array of detectors, a thermal interface material located between each microelectronic device and an adjacent thermally conductive via of the thermally conductive vias.
Example 9: The assembly of Example 8, wherein the carrier comprises thermal spreaders in contact with groupings of the thermally conductive vias, the thermal spreaders located on a side of the second substrate opposite the array of detectors.
Example 10: The assembly of any one of Examples 6 through 9, wherein the connector comprises an edge connector or a pin connector.
Example 11: The assembly of any one of Examples 6 through 10, wherein the carrier comprises mechanical attachment structures located on a side of the carrier opposite the array of detectors, the mechanical attachment structures positioned and configured to mechanically secure the carrier to, and align the carrier with respect to, a support.
Example 12: The assembly of any one of Examples 6 through 11, wherein the mechanical attachment structures comprise posts having threaded bores for receiving bolts therein.
Example 13: The assembly of any one of Examples 6 through 12, wherein the array of detectors comprises four detectors arranged in a grid on the carrier.
Example 14: The assembly of any one of Examples 6 through 13, further comprising an interposer located between and electrically connected to the array of anodes and the first substrate.
Example 15: The assembly of any one of Examples 6 through 14, wherein a first, greatest height of the microelectronic device as measured from the first substrate in a direction perpendicular to a closest major surface of the substrate is less than or equal to a second, smallest height of the electrically conductive elements as measured from the first substrate in the direction.
Example 16: A computed tomography scanner, comprising: a radiation source; and a detector positioned, oriented, and configured to receive at least a portion of radiation emitted by the radiation source, the detector comprising an array of detection assemblies, at least one of the detection assemblies comprising: an array of detectors, each detector of the array of detectors comprising: a cathode; a detector material capable of converting each photon received at the detector material into an electrical signal to perform photon counting computed tomography, the detector material adjacent to the cathode; and an array of anodes located on a side of the detector material opposite the cathode; a first substrate facing the array of anodes, anodes of the array of anodes electrically connected to the substrate; and a microelectronic device located on a side of the substrate opposite the detector material, the microelectronic device electrically connected to the substrate with the microelectronic device mounted to the substrate in a flip-chip orientation; and a carrier supporting the array of detectors, the carrier comprising: a second substrate electrically connected to each first substrate of the array of detectors by electrically conductive elements located laterally adjacent to the microelectronic device and in contact with respective first substrates and the second substrate; and a connector located on a side of the second substrate opposite the array of detectors, the connector electrically connected to the electrically conductive elements.
Example 17: The computed tomography scanner of Example 16, wherein at least some detection assemblies of the array of detection assemblies are located laterally and longitudinally adjacent to other detection assemblies of the array of detection assemblies.
Example 18: The computed tomography scanner of Example 16 or Example 17, an interposer located between and electrically connected to the array of anodes and the first substrate.
Example 19: The computed tomography scanner of any one of Examples 16 through 18, wherein: the carrier comprises thermally conductive vias extending at least partially through the second substrate and located proximate to respective microelectronic devices of the array of detectors, a thermal interface material located between each microelectronic device and an adjacent thermally conductive via of the thermally conductive vias; and the carrier comprises thermal spreaders in contact with groupings of the thermally conductive vias, the thermal spreaders located on a side of the carrier opposite the array of detectors and proximate to the connector.
Example 20: The computed tomography scanner of any one of Examples 16 through 19, wherein the array of detectors comprises four detectors arranged in a grid on the carrier.

While certain illustrative examples have been described in connection with the figures, those of ordinary skill in the art will recognize and appreciate that the scope of this disclosure is not limited to those examples explicitly shown and described in this disclosure. Rather, many additions, deletions, and modifications to the embodiments described in this disclosure may be made to produce examples within the scope of this disclosure, such as those specifically claimed, including legal equivalents. In addition, features from one disclosed example may be combined with features of another disclosed example while still being within the scope of this disclosure.

What is claimed is:

1. A detector for a computed tomography scanner, comprising:
a cathode;
a cadmium telluride material, a cadmium zinc telluride material, or a silicon material adjacent to the cathode,
an array of anodes located on a side of the cadmium telluride material, the cadmium zinc telluride material, or the silicon material opposite the cathode;
a substrate located proximate to the array of anodes, anodes of the array of anodes electrically connected to the substrate;
a microelectronic device located on a side of the substrate opposite the cadmium telluride material, the cadmium zinc telluride material or the silicon material, the microelectronic device electrically connected to the substrate with the microelectronic device mounted on the substrate in a flip-chip orientation; and
electrically conductive elements located adjacent to the microelectronic device and electrically connected to the substrate.

2. The detector of claim 1, wherein the microelectronic device comprises an application-specific integrated circuit (ASIC).

3. The detector of claim 1, wherein a first, greatest height of the microelectronic device as measured from the substrate in a direction perpendicular to a closest major surface of the substrate is less than or equal to a second, smallest height of the electrically conductive elements as measured from the substrate in the direction.

4. The detector of claim 1, wherein the electrically conductive elements are located in rows flanking the microelectronic device and extending along lateral peripheries of the substrate.

5. The detector of claim 1, further comprising an interposer located between the array of anodes and the substrate, and electrically connected to the array of anodes and the substrate.

6. An assembly of detectors for a computed tomography scanner, comprising:
an array of detectors, each detector of the array of detectors comprising:
a cathode;
a detector material capable of converting each photon received at the detector material into an electrical signal to perform photon counting computed tomography, the detector material in contact with the cathode; and
an array of anodes located on a side of the detector material opposite the cathode;
a first substrate facing the array of anodes, anodes of the array of anodes electrically connected to the substrate; and
a microelectronic device located on a side of the substrate opposite the detector material, the microelectronic device electrically connected to the substrate with the microelectronic device mounted to the substrate in a flip-chip orientation; and
a carrier supporting the array of detectors, the carrier comprising:
a second substrate electrically connected to each first substrate of the array of detectors by electrically conductive elements located laterally adjacent to the microelectronic device and in contact with respective first substrates and the second substrate; and
a connector located on a side of the second substrate opposite the array of detectors, the connector electrically connected to the electrically conductive elements.

7. The assembly of claim 6, wherein the detector material comprises a cadmium telluride material, a cadmium zinc telluride material, or a silicon material.

8. The assembly of claim 6, wherein the carrier comprises thermally conductive vias extending at least partially through the second substrate and located proximate to respective microelectronic devices of the array of detectors, a thermal interface material located between each microelectronic device and an adjacent thermally conductive via of the thermally conductive vias.

9. The assembly of claim 8, wherein the carrier comprises thermal spreaders in contact with groupings of the thermally conductive vias, the thermal spreaders located on a side of the second substrate opposite the array of detectors.

10. The assembly of claim 6, wherein the connector comprises an edge connector or a pin connector.

11. The assembly of claim 6, wherein the carrier comprises mechanical attachment structures located on a side of the carrier opposite the array of detectors, the mechanical attachment structures positioned and configured to mechanically secure the carrier to, and align the carrier with respect to, a support.

12. The assembly of claim 11, wherein the mechanical attachment structures comprise posts having threaded bores for receiving bolts therein.

13. The assembly of claim 6, wherein the array of detectors comprises four detectors arranged in a grid on the carrier.

14. The assembly of claim 6, further comprising an interposer located between and electrically connected to the array of anodes and the first substrate.

15. The assembly of claim 6, wherein a first, greatest height of the microelectronic device as measured from the first substrate in a direction perpendicular to a major surface of the substrate is less than or equal to a second, smallest height of the electrically conductive elements as measured from the first substrate in the direction.

16. A computed tomography scanner, comprising:
a radiation source; and
a detector positioned, oriented, and configured to receive at least a portion of radiation emitted by the radiation source, the detector comprising an array of detection assemblies, at least one of the detection assemblies comprising:
an array of detectors, each detector of the array of detectors comprising:
a cathode;
a detector material capable of converting each photon received at the detector material into an electrical signal to perform photon counting computed tomography, the detector material adjacent to the cathode; and
an array of anodes located on a side of the detector material opposite the cathode;
a first substrate facing the array of anodes, anodes of the array of anodes electrically connected to the substrate; and
a microelectronic device located on a side of the substrate opposite the detector material, the microelectronic device electrically connected to the substrate with the microelectronic device mounted to the substrate in a flip-chip orientation; and
a carrier supporting the array of detectors, the carrier comprising:
a second substrate electrically connected to each first substrate of the array of detectors by electrically conductive elements located laterally adjacent to the microelectronic device and in contact with respective first substrates and the second substrate; and
a connector located on a side of the second substrate opposite the array of detectors, the connector electrically connected to the electrically conductive elements.

17. The computed tomography scanner of claim 16, wherein at least some detection assemblies of the array of detection assemblies are located laterally and longitudinally adjacent to other detection assemblies of the array of detection assemblies.

18. The computed tomography scanner of claim 16, an interposer located between and electrically connected to the array of anodes and the first substrate.

19. The computed tomography scanner of claim 16, wherein:
the carrier comprises thermally conductive vias extending at least partially through the second substrate and located proximate to respective microelectronic devices of the array of detectors, a thermal interface material located between each microelectronic device and an adjacent thermally conductive via of the thermally conductive vias; and
the carrier comprises thermal spreaders in contact with groupings of the thermally conductive vias, the thermal spreaders located on a side of the carrier opposite the array of detectors and proximate to the connector.

20. The computed tomography scanner of claim 16, wherein the array of detectors comprises four detectors arranged in a grid on the carrier.
